(19) United States
(12) Patent Application Publication
(10) Pub. No.: US 2025/0130022 A1
(43) Pub. Date: Apr. 24, 2025

(54) LASER SYSTEM

(71) Applicant: Applied Research Associates, Inc., Albuquerque, NM (US)

(72) Inventors: Joseph Nolan Paranto, Albuquerque, NM (US); Christopher Scott Church, Panama City, FL (US); Sebastian MacNamara, Panama City Beach, FL (US)

(21) Appl. No.: 18/921,468

(22) Filed: Oct. 21, 2024

Related U.S. Application Data
(60) Provisional application No. 63/592,682, filed on Oct. 24, 2023.

(51) Int. Cl. F41H 13/00; B63G 8/00; B63G 8/28; B63G 8/36; B64U 10/25; B64U 20/90; B64U 101/15; B64U 101/70; F41A 23/34; G02B 6/42

(52) U.S. Cl. CPC F41H 13/005; B63G 8/001; B63G 8/28; B63G 8/36; B64U 10/25; B64U 20/90; F41A 23/34; G02B 6/4296; B63G 2008/004; B64U 2101/15; B64U 2101/70; B64U 2201/104

(57) ABSTRACT

A method, system, and computer-readable media for providing a mountable directed-energy system comprising a directed-energy source for generating and transmitting directed-energy. At least a portion of the directed-energy system may be mounted to one or more other devices such as any of a vehicle, drone, or other manually operated, autonomous, or semi-autonomous system.

### RELATED APPLICATIONS

This patent application claims priority benefit, with regard to all common subject matter, of U.S. Provisional Patent Application No. 63/592,682, filed Oct. 24, 2023, and entitled “LASER SYSTEM.” The above-referenced application is hereby incorporated by reference in its entirety into the present application.

This patent application shares certain subject matter in common with earlier-filed U.S. Provisional Patent Application No. 62/690,067, filed Jun. 26, 2018, and U.S. Pat. No. 10,900,755, filed Jun. 21, 2019, both of which are entitled “LASER WEAPON SYSTEM.” This patent application shares certain subject matter in common with earlier-filed U.S. patent application Ser. No. 18/175,209, filed Feb. 27, 2023, and entitled “MULTI-FLUID HEAT EXCHANGER FOR A LASER SYSTEM.” The above-referenced applications and patent are hereby incorporated by reference in their entirety into the present application.

### BACKGROUND

### 1. Field

Embodiments of the present disclosure relate to directed-energy systems. More specifically, embodiments of the present disclosure relate to tactical mobile directed-energy systems.

### 2. Related Art

Directed-energy systems, such as laser weapon systems provide a range of tactical abilities, such as counter-explosive applications, such as detonation of unexploded ordinance (UXO), improvised explosive devices (IEDs), or mines, counter-infrastructure applications, such as destroying target communications systems, cameras, power systems, radar, lights, power systems, or locks, and counter-moving-target applications, such as incapacitating or destroying airborne, terrestrial, or maritime unmanned drones. However, said systems lack mobility and further require human operators to be present during operation.

### SUMMARY

Embodiments of the present disclosure solve the above-mentioned problems by providing a directed-energy system configured to be mounted to one or more devices for mobile and remote operation.

In some aspects, the techniques described herein relate to a laser weapon system configured to be coupled to at least one vehicle, the laser weapon system including: a laser source portion including: a power source; a laser generator; a thermal regulation unit; and a control unit; at least one fiber optic cable attached to the laser generator; a laser projector portion coupled to the laser source portion via the at least one fiber optic cable such that a laser produced by the laser generator is provided to the laser projector portion, the laser projector portion including laser transmitter optics configured to focus a laser at a target, wherein the laser projector portion is configured to be mounted on the at least one vehicle.

In some aspects, the techniques described herein relate to a laser weapon system, wherein the laser weapon system is integrated into an at least semi-autonomous drone, and wherein the laser projector portion is mounted onto a portion of the at least semi-autonomous drone.

In some aspects, the techniques described herein relate to a laser weapon system, wherein the laser weapon system configured to be disposed on an automobile, and wherein the laser projector portion is mounted onto a selectively removable turret weapon system removably mounted to the automobile.

In some aspects, the techniques described herein relate to a laser weapon system, wherein the at least one vehicle is a subterranean drone, and wherein the laser projector portion is mounted onto a front portion of the subterranean drone.

In some aspects, the techniques described herein relate to a laser weapon system, wherein the laser generation portion is disposed at a surface portion located at a distinct location from the subterranean drone.

In some aspects, the techniques described herein relate to a laser weapon system, wherein the subterranean drone is tethered to the at least one fiber optic cable.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 illustrates an exemplary diagram of a laser system relating to some aspects of the present disclosure;

FIG. 2 illustrates an exemplary vehicle-mounted laser system disposed on a vehicle relating to some embodiments of the present disclosure;

FIG. 3 illustrates an exemplary drone-mounted laser system mounted to an aerial drone relating to some embodiments of the present disclosure;

FIG. 4 illustrates an exemplary submarine-mounted laser system mounted to a submarine drone relating to some embodiments of the present disclosure;

FIG. 5 illustrates an exemplary subterranean drone-mounted laser system mounted to a subterranean drone relating to some embodiments of the present disclosure;

FIG. 6 illustrates an exemplary control system for a laser system relating to some embodiments of the present disclosure;

FIG. 7 illustrates an exemplary method of operation for a laser system relating to some embodiments of the present disclosure; and

FIG. 8 illustrates an exemplary cooling system for cooling the laser system relating to some embodiments of the present disclosure.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

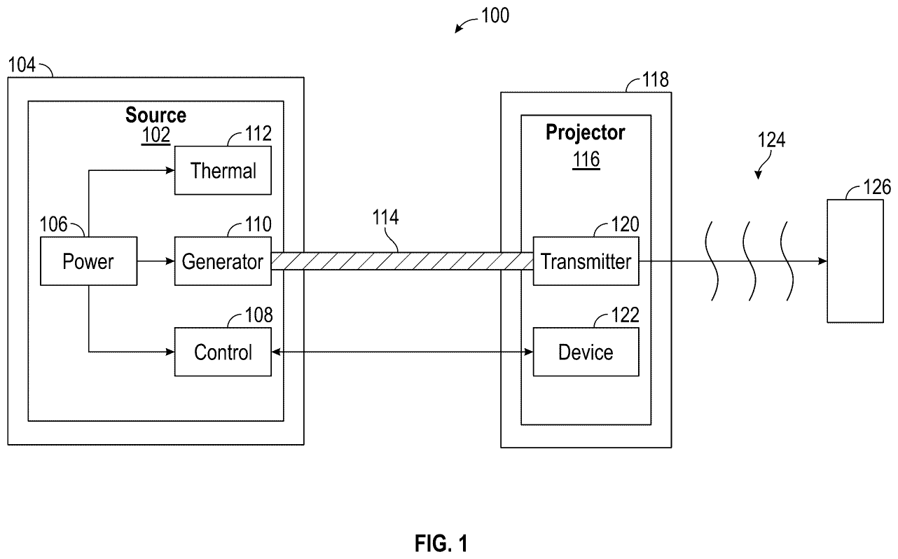

FIG. 1 illustrates an exemplary diagram of a laser system 100 relating to some aspects of the present disclosure. In some such aspects, the laser system 100 comprises a laser source 102 including any of a housing structure 104, a power source 106, a control unit 108, a laser generator 110, and a thermal regulation unit 112.

In some aspects of the disclosure, each of the power source 106, the control unit 108, the laser generator 110, and the thermal regulation unit 112 is disposed within the housing structure 104, as shown. However, embodiments are contemplated in which the components may be included within multiple separate housing structures or external to the housing structure 104.

The power source 106 may include any of a battery, generator, capacitor, or other suitable source of electrical power. Further, in some aspects, other forms of power are contemplated such as hydraulic power. In such cases of electrical power, the power source 106 is electrically coupled to one or more of the control unit 108, the laser generator 110, and the thermal regulation unit 112 to thereby provide electrical power to the laser source 102. Additionally, embodiments are contemplated in which a plurality of power sources are included. For example, a first power source may provide power to the laser generator 110, while a second power source distinct from the first power source provides power to the control unit 108 and the thermal regulation unit 112. Such an arrangement with a first and second power source may be suitable for embodiments in which the laser generator 110 operates at a much higher current than the other components. Accordingly, the second power source may be smaller and provide lower current power for the control unit 108 and thermal regulation unit 112, which operate at a much lower current than the laser generator 110 and consume considerably less energy. Further still, embodiments are contemplated in which the power source 106 comprises an external power source disposed outside of the housing structure 104 or, in some cases, entirely separate from the laser system 100. For example, in some embodiments, the laser system 100 may be electrically coupled to an external power source of an external system, such as a car battery of a vehicle on which the laser system 100 is mounted or otherwise coupled to.

The control unit 108 may include any combination of processors, transistors, and other electronics for controlling one or more operations of the laser system 100. In some embodiments, the control unit 108 comprises at least one processor configured to execute a plurality of steps according to a set of non-transitory computer-readable media comprising computer-executable instructions. For example, the control unit 108 may be programmed to control operation of the laser generator 110 automatically or based on manual operator input. Further, the control unit 108 may be communicatively coupled to each of the laser generator 110 and the thermal regulation unit 112 such that the control unit 108 can control operations of the thermal regulation unit 112 such as activating one or more fans, pumps, or other selectively activated components associated with the thermal regulation unit 112.

The laser generator 110 may comprise any suitable form of laser generation module known or later developed. For example, in some embodiments, the laser generator 110 includes one or more laser pump diodes for producing a laser. Further, in some embodiments, the laser generator 110 may include a seed laser integrated with one or more stages of amplifying fibers.

The thermal regulation unit 112 is configured to provide thermal regulation to at least a portion of the laser system 100. For example, in some embodiments, the thermal regulation unit 112 provides cooling to the laser generator 110, which generates large amounts of waste heat during operation. Here, the thermal regulation unit 112 may be at least partially fluidly connected or physically connected to the laser generator 110 for absorbing waste heat produced by operation of the laser generator 110. In some embodiments, the thermal regulation unit 112 comprises a Phase Change Material (PCM)-based heat mitigation module with one or more PCMs that are configured to absorb heat from the laser generator 110 as latent heat, which melts the PCM. Additionally, or alternatively, the thermal regulation unit 112 may include any one of or combination of chillers, liquid heat exchanger, fans, pumps, manifolds, and other components suitable to provide cooling to the laser system 100.

In some embodiments, at least one fiber optic cable 114 is coupled to the laser generator 110, as shown. Accordingly, the fiber optic cable 114 may be configured to transfer a laser produced by the laser generator 110 to a laser projector 116. For example, the fiber optic cable 114 may provide a tether between the laser source 102 and a device with the laser projector 116 mounted thereto. Alternatively, or additionally, in some embodiments, the laser source 102 may be coupled directly to the laser projector 116 such that the fiber optic cable 114 may not be used as a tether or may be much shorter. For example, in some such embodiments, the laser source 102 and the laser projector 116 may be included in the same housing structure 104 such that a tether is not needed.

In some embodiments, the laser projector 116 comprises a mounting structure 118 configured to secure the laser projector 116 to at least one vehicle or other device. For example, the mounting structure 118 may be operable to mount the laser projector 116 to any of an automobile, a drone, a robotic device, a weapon system, and a submarine, as well as any other form of terrestrial, non-terrestrial, aquatic, aerial, and autonomous, semi-autonomous, or manually controlled device. The mounting structure 118 may include any form of fasteners, brackets, straps, and other connectors operable to removably or permanently attach the laser projector 116 to the vehicle or other device.

The laser projector 116 comprises a laser transmitter 120 including transmitter optics disposed therein or thereon. For example, in some embodiments, the transmitter optics of the laser transmitter 120 are supported on the mounting structure 118. The laser projector 116 may be secured, via the mounting structure 118, to a device 122. The device 122, as described above, may comprise any suitable form of vehicle, weapon, or other device for which the laser projector 116 is mounted to.

In some embodiments, the laser transmitter 120 is configured to focus a laser provided by the laser generator 110 and transmit the laser. In some cases, the laser transmitted by the laser transmitter 120 travels through an atmosphere 124 between the laser projector 116 toward a target 126. For example, the atmosphere 124 may comprise any of air, water, other fluids, or lack thereof. In some embodiments, the laser projector 116 may be configured to adjust certain parameters of the laser based on the atmosphere 124. For example, the laser focal length may be adjusted to compensate for thick atmospheres. Similarly, the laser may be adjusted to travel through water or other atmospheric or fluid conditions.

In some embodiments, the laser projector 116 may be configured to generate a laser that is invisible or at least minimally visible to the human eye. For example, the generated laser may consist of infrared light, which is outside of the visible range of humans. Accordingly, the laser projector 116 may comprise an infrared laser emitter configured to generate and focus an infrared beam.

In some embodiments, various additional components may be included for focusing and strengthening the beam produced at the laser projector 116. For example, the laser projector 116 may comprise a two lens optical telescope for increasing the intensity of the laser at range. It should be understood that other forms of telescopes and lenses not explicitly described herein are also contemplated. Further, in some embodiments, the laser source 102 may further comprise one or more laser amplifiers coupled to the laser generator 110 configured to amplify the laser.

In some embodiments, various control and safety features may be included for the laser system 100. For example, a laser operation inhibitor may be included for preventing laser operation based on a firing angle of the laser transmitter 120. As an example, the laser system 100 may further include one or more inclinometers for detecting an angle or tilt of the laser projector 116 with respect to gravity and laser operation is inhibited based on determining that the angle of the laser projector 116 is above a minimum threshold angle. Such inhibiting of laser operation based on an angle of orientation of the laser projector 116 may be performed to comply with standards set by the Laser Clearing House of the United States Air Force that regulate firing a high power laser into space.

Embodiments above are described with respect to laser systems; however, it should be understood that similar systems may be used for other types of directed-energy systems. For example, a directed-energy system may include a thermal regulation unit for cooling a directed-energy generator after and during use.

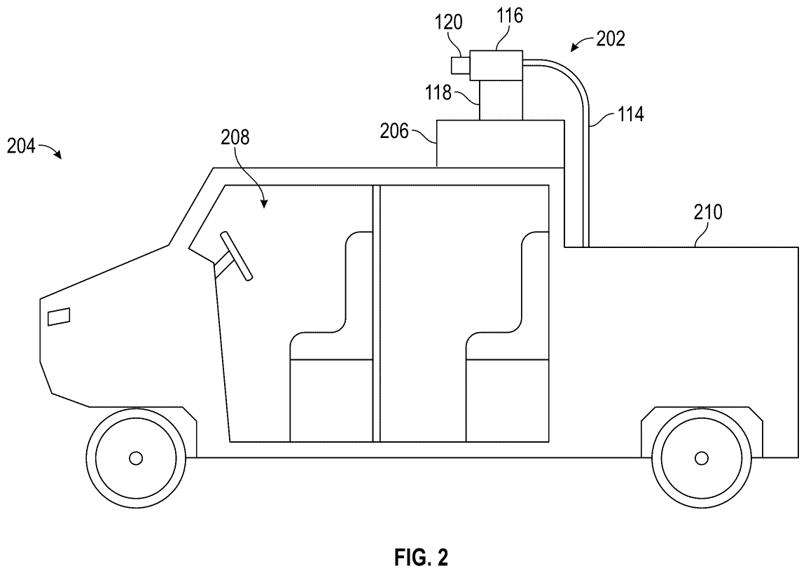

FIG. 2 illustrates an exemplary vehicle-mounted laser system 202 disposed on a vehicle 204 relating to some embodiments of the present disclosure. The vehicle-mounted laser system 202 may comprise any combination of the components described above with respect to the laser system 100. For example, the exemplary vehicle-mounted laser system 202 may comprise the fiber optic cable 114, the laser projector 116, the mounting structure 118, and the laser transmitter 120.

The vehicle 204 may be any suitable form of vehicle such as an automobile. In some embodiments, the vehicle 204 may be a military vehicle 204, as shown, comprising a laser mounting portion 206 configured to receive the exemplary vehicle-mounted laser system 202, a cab portion 208, and a bed portion 210, as well as other vehicle components such as a battery, wheels, seats, lights, a frame, and other components typically included in a vehicle. In some embodiments, the vehicle-mounted laser system 202 may be mounted to the vehicle 204 above the cab portion 208, as shown. However, it should be understood, in some embodiments, that the exemplary vehicle-mounted laser system 202 may be mounted elsewhere within the vehicle 204. For example, in some embodiments, the exemplary vehicle-mounted laser system 202 may be disposed within the bed portion 210 or at least partially within the cab portion 208.

In some embodiments, certain portions of the vehicle-mounted laser system 202 may be mounted within or integrated with the vehicle 204. For example, the laser source 102 may be included within a portion of the vehicle 204. Further, in some such embodiments, the power source 106 may be replaced with a battery of the vehicle 204, or other power source included on the vehicle. For example, the laser generator 110 may be electrically coupled to the battery of the vehicle 204.

In some embodiments of the present disclosure physical structures for improving accuracy and stabilization of the laser source 102 may be included. For example, either or both of the laser mounting portion 206 and the mounting structure 118 may include one or more vibration damping structures for mitigating the effects of vibration and shock associated with driving the vehicle 204 while operating the laser source 102. Said vibration damping structures may include any combination of springs, cushions, rubber plates, bushing dampers, or other suitable forms of vibration mitigation structures.

Additionally, or alternatively, in some embodiments, the mounting structure 118 may be removably mounted to the laser mounting portion 206 of the vehicle 204. For example, in some such embodiments, the vehicle-mounted laser system 202 is integrated into a selectively removable turret weapon system removably mounted to the vehicle 204. Accordingly, the removable turret weapon system may be removed at least partially from the vehicle for non-vehicle mounted use. In some such cases, the vehicle-mounted laser system 202 may be coupled to the vehicle 204 for replenishing power and providing laser generation through the fiber optic cable 114. Alternatively, in some embodiments, the vehicle-mounted laser system 202 is fully removable from the vehicle 204 and a portion of the exemplary vehicle-mounted laser system 202 may be configured to be placed into a compartment of the vehicle 204 or otherwise temporarily connected to the vehicle 204 for recharging a power source of the vehicle-mounted laser system 202 or replenishing a phase change material of the thermal regulation unit 112.

The vehicle-mounted laser system 202 is described above with respect to a manned terrestrial vehicle such as the vehicle 204, however, it should be understood that the vehicle-mounted laser system 202 and other laser systems described herein may be configured to be mounted or incorporated into any suitable vehicle or device such as manned and unmanned terrestrial vehicles, manned and unmanned watercraft, and manned and unmanned aircraft, as will be described in further detail below.

The vehicle-mounted laser system 202 is described with respect to a laser system. However, it should be understood that other forms of directed-energy systems are also contemplated for mounting to vehicles. For example, a millimeter wave system may be mounted to the vehicle and a cooling system may be provided for cooling a wave generator of the millimeter wave system.

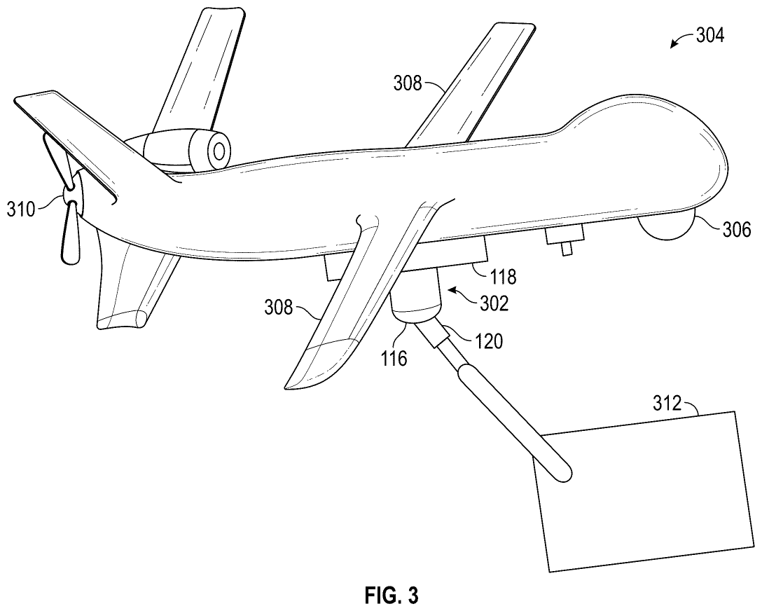

FIG. 3 illustrates an exemplary drone-mounted laser system 302 mounted to an aerial drone 304 relating to some embodiments of the present disclosure. The drone- mounted laser system 302 may comprise any of the components of the laser system 100 described above, as well as additional components not explicitly shown or described herein. For example, the drone-mounted laser system 302 may comprise the laser projector 116 secured to the aerial drone 304 via the mounting structure 118, and the laser transmitter 120.

In some embodiments, the laser projector 116 of the drone-mounted laser system 302 may be independently moveable such that the laser can be selectively aimed in a particular direction. In some such embodiments, the laser projector 116 may be mounted to a gimbal or other form of selectively moveable/rotatable mounting structure. Additionally, or alternatively, embodiments are contemplated in which the laser projector 116 is mounted at an end of a robotic arm or other automatically moveable structure.

The aerial drone 304 may be an unmanned aerial drone, such as, for example, an unmanned fixed-wing drone, as shown. Alternatively, or additionally, in some embodiments, any suitable form of aerial and other form of drone is contemplated. For example, the drone-mounted laser system 302 may also be mounted onto a multi-rotor drone, a single-rotor drone, or a vertical take-off and landing (VTOL) drone, as well as other types of drones not explicitly described herein.

The aerial drone 304 may comprise an image sensor system 306, which may comprise one or more cameras configured to capture real-time image data associated with a remote operating environment of the aerial drone 304. Additionally, the aerial drone 304 may comprise one or more wings 308. For example, the wings 308 may be disposed at either side of a base portion of the aerial drone 304, as shown. Further, the aerial drone 304 may include a propellor 310. Additionally, or alternatively, the aerial drone 304 may include any combination of other components not explicitly shown herein, such as, one or more rotors, a location tracking system, avionics, a gimbal control unit, a data link or wireless transmitter, a flight control system, one or more radar sensors, as well as other components not explicitly described herein.

The drone-mounted laser system 302 and aerial drone 304 may be used in combination to perform a variety of operations such as, reconnaissance, destroying aerial and ground targets including other autonomous and semi-autonomous drones. For example, the drone-mounted laser system 302 may be configured to focus a laser at a target 312, as shown. Additionally, in some embodiments, the drone-mounted laser system 302 may be used to destroy grounded structures for aiding operation and traversal of human operators. For example, a laser from the drone-mounted laser system 302 may be focused at a door lock or wall to allow human operators to access an otherwise inaccessible area of an operating environment. In such embodiments, a GPS system of the aerial drone 304 may be communicatively coupled to a location device associated with the ground operators to thereby aid in positioning and tracking and preventing the laser from being fired within the direct vicinity of the human operators. Additionally, the human operators may be informed of the position of the aerial drone 304 based on communicative coupling of the GPS data from the aerial drone 304.

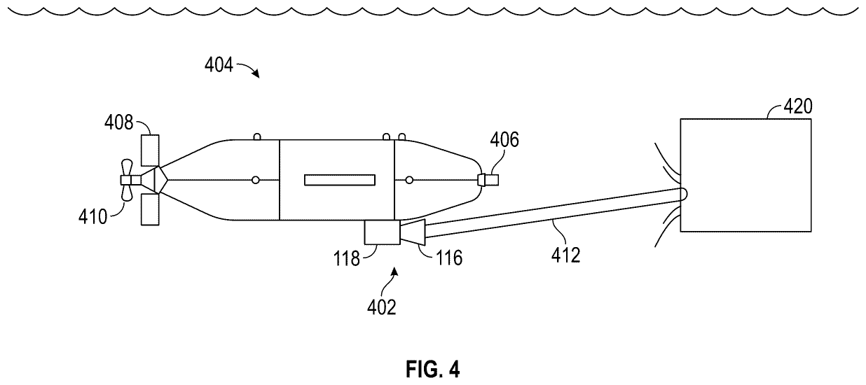

FIG. 4 illustrates an exemplary submarine-mounted laser system 402 mounted to a submarine drone 404 relating to some embodiments of the present disclosure. The submarine drone 404 is configured to be disposed under water within an aquatic environment such as any of a pond, lake, ocean, pool, sea, or other body of water. In some embodiments, the submarine drone 404 may be configured with a predefined pressure rating for suitability in deep sea operations such as underwater mine detection and disposal. For example, the submarine drone 404 may be used to position the exemplary submarine-mounted laser system 402 for quiet disarmament of underwater mines or the like.

The submarine-mounted laser system 402 comprises the mounting structure 118, which may be configured to be mounted to at least a portion of the submarine drone 404, as shown. In some embodiments, the mounting structure 118 is configured to be mounted to a bottom portion of the submarine drone 404, as shown. Additionally, the exemplary submarine-mounted laser system 402 may comprise the laser projector 116 mounted to the mounting structure 118. Accordingly, the laser projector 116 may be selectively controlled to direct a laser 412 in a particular direction. Alternatively, embodiments are contemplated in which the laser projector 116 may be statically mounted to the submarine drone 404 such that the laser 412 is aimed based on the orientation of the submarine drone 404.

The submarine drone 404 comprises at least one sensor 406. The sensor 406 may be disposed on a front portion of the submarine drone 404 as shown for sensing one or more parameters of the surroundings of the submarine drone 404. For example, in some embodiments, the at least one sensor 406 may comprise any one of or combination of a camera, microphone, accelerometer, temperature sensor, location sensor, or other suitable sensors disposed on the submarine drone 404.

The submarine drone 404 further comprises one or more rudders 408 configured to steer the submarine drone 404. In some embodiments, the rudders 408 are controlled manually based on remote operator input. Alternatively, or additionally, in some embodiments, the rudders 408 may be controlled at least semi-autonomously. For example, an automatic path determination algorithm may be executed to determine a motion path of the submarine drone 404 based at least in part on location data such as GPS data collected by a GPS receiver, transceiver, transceiver, or the like, as well as another suitable form of location sensor disposed on the submarine drone 404.

In some embodiments, the submarine drone 404 may be propelled through water via at least one propeller 410 disposed on a rear portion of the submarine drone 404, as shown. The propeller 410 may also be controlled either manually or autonomously based at least in part on location data associated with the submarine drone 404.

In some embodiments, the laser 412 may be directed at a target 420, as shown. For example, the target 420 may comprise any of an underwater explosive such as a submersible mine, underwater munitions, submersible security cameras, submersible lights, submersible communication links, submersible power lines, or other underwater structures. Further, in some embodiments, active targets are contemplated such as an enemy drone, submarine, or the like.

In some embodiments, one or more parameters of the laser projector 116 may be altered to tune the laser projector 116 for underwater use. For example, in some embodiments, a light spectrum for the laser projector 116 may be selected within a blue-green spectrum to permit underwater use due to red and ultraviolet lights being prone to being absorbed water. Further, the submarine-mounted laser system 402 may have one or more structural components configured for underwater use. For example, sensitive internal components of the laser projector 116 may be sealed and covered to prevent water from contacting said components and to protect said components from pressure associated with deep sea travel. Further still, in some embodiments, a wavelength for the laser projector 116 may be selected for underwater use. For example, in some embodiments, a wavelength of between about 500 nanometers to about 550 nanometers may be used. However, it should be understood that other suitable wavelengths may be used and, in some embodiments, the wavelength may be further selected based on a firing distance desired for a particular operating environment.

In some embodiments, the submarine-mounted laser system 402 may be configured to be mounted on other forms of watercraft besides the autonomous submarine drone, such as, a manned submarine, a boat, a ship, or other suitable form of watercraft. For example, embodiments are contemplated in which the submarine-mounted laser system 402 is disposed on a front portion of a submarine or other form of watercraft and configured to produce a laser to melt ice in front of the submarine for traversal through ice covered bodies of water. In some such embodiments, the submarine-mounted laser system 402 may be used to melt and cut surface ice to create a hole for resurfacing the submarine. The laser system configured to melt ice may be used for resurfacing in cold environments where surfacing would otherwise be impossible or dangerous to structural components of the submarine.

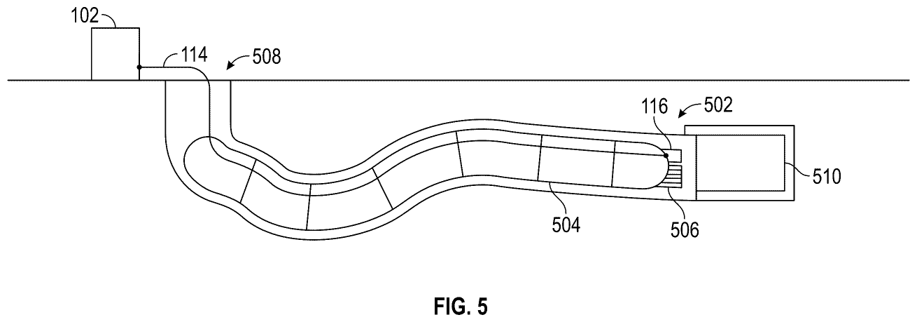

FIG. 5 illustrates an exemplary subterranean drone-mounted laser system 502 mounted to a subterranean drone 504 relating to some embodiments of the present disclosure. The subterranean drone 504 may include a semi-autonomous or fully autonomous robotic system configured for underground operation.

The subterranean drone-mounted laser system 502 may comprise the laser projector 116, as described above, which may be mounted to a front portion of the subterranean drone 504, as shown. In some such embodiments, the laser source 102 may be disposed elsewhere, such as at a surface portion in a distinct location from the subterranean drone 504, as shown. Accordingly, the laser projector 116 may be tethered to the laser source 102 via the fiber optic cable 114, as shown. In some such embodiments, the fiber optic cable 114 provides a laser transmission path to transfer laser energy generated at the laser source 102 to the laser projector 116. Alternatively, in some embodiments, the laser source 102 may also be mounted on or coupled to the subterranean drone 504. In some embodiments, a communications cable may also be included or may integrated into the fiber optic cable 114.

In some embodiments, the subterranean drone 504 comprises a digging mechanism 506 configured to tunnel through a substrate. Accordingly, the digging mechanism 506 may be used to create a tunnel 508 for the subterranean drone 504 to travel through.

A variety of different forms of digging mechanisms for the subterranean drone 504 are contemplated. For example, in some embodiments, the digging mechanism 506 may comprise any combination of drills, shovels, augers, chain trenchers, wheel trenchers, excavators, explosives, or other suitable means for generating the tunnel 508. Further, in some embodiments, ultrasonic forms of digging are contemplated. For example, the digging mechanism 506 may comprise an ultrasonic actuator configured to generate vibration waves that permeate through and loosen ground material in front of the subterranean drone 504. In some such embodiments, the ultrasonic actuator may be used in combination with one or more other forms of digging mechanisms. For example, the ultrasonic actuator may be included along with a physical drill such that the vibrations from the ultrasonic actuator aid in loosening ground material prior to physical contact with the drill. Further still, in some embodiments, the subterranean drone-mounted laser system 502 may be used to supplement digging action of the subterranean drone 504. For example, the laser projector 116 may transmit a laser configured to heat a surrounding ground material to aid in digging action.

The subterranean drone-mounted laser system 502 and subterranean drone 504 are operable to perform a variety of underground operations including any of reconnaissance, destroying underground munitions or other structures, and disarming/detonating underground explosives or other forms of underground weapons. For example, the subterranean drone-mounted laser system 502 may be configured to focus a laser at a target 510 disposed underground, as shown. Additionally, embodiments are contemplated in which the subterranean drone 504 may traverse an underground environment and then resurface to perform an above ground operation such as destroying munitions disposed above ground.

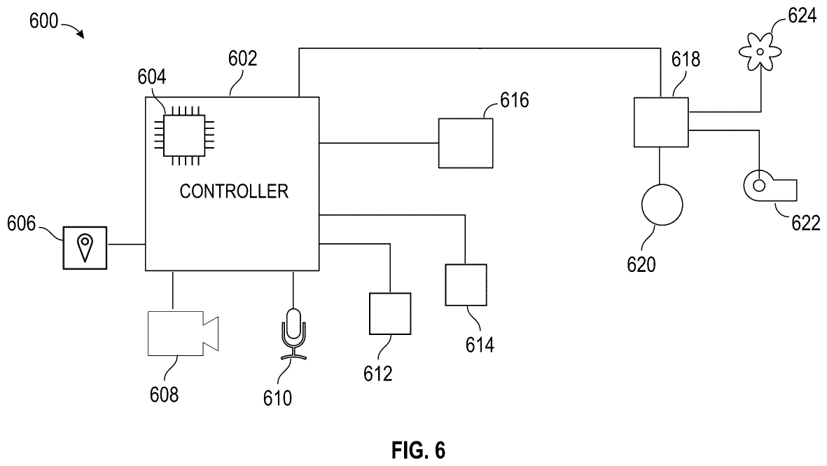

FIG. 6 illustrates an exemplary control system 600 for a laser system relating to some embodiments of the present disclosure. The control system 600 may be coupled to or integrated into the laser system 100, as described above. Additionally, or alternatively, in some embodiments, the control system 600 may be coupled to any suitable system described above such as any of the vehicle 204, aerial drone 304, submarine drone 404, or subterranean drone 504.

The control system 600 comprises a controller 602 including at least one processor 604. In some embodiments, the controller 602 is coupled to at least a portion of the laser system 100. For example, the controller 602 may be included on or coupled to the control unit 108 of the laser system 100.

In some embodiments, the controller 602 may include or be coupled to any number of sensors and other components. For example, the controller 602 is communicatively coupled to any combination of at least one GPS receiver (or transceiver) 606, at least one camera 608 (or other visual sensor), at least one microphone 610 (or other audio sensors), at least one accelerometer 612, and at least one inclinometer 614.

In some embodiments, any combination of the GPS receiver 606, the at least one accelerometer 612, and the at least one inclinometer 614 may be used for targeting of the laser weapon system. For example, GPS data from the GPS receiver 606 and acceleration data from the accelerometer 612 may be used to automatically aim the laser weapon system at a target. Further, embodiments are contemplated in which inclination data from the inclinometer 614 may be used to temporarily limit firing of the laser weapon system when the laser system is positioned above a predetermined inclination to thereby prevent firing of the laser into the air. Further still, in some embodiments, firing of the laser system may be limited based on any combination of data from one or more sensors coupled to the controller 602, for example to prevent the laser system from firing upon non-targets or other objects.

The controller 602 is further communicatively coupled to one or more other control portions such as a laser control unit 616 and a thermal control unit 618. Accordingly, the controller 602 is operable to instruct one or more operations of the laser control unit 616 and the thermal control unit 618. The thermal control unit 618 may include or be coupled to any number of sensors such as at least one temperature sensor 620. In some embodiments, the temperature sensor 620 may be disposed on or in at least a portion of the laser system 100. For example, the temperature sensor 620 may be disposed within a heat exchanger or heat mitigation portion of the laser system 100. Alternatively, or additionally, one or more temperature sensors may be disposed on the laser projector 116 to monitor a temperature of the laser projector 116.

In some embodiments, the thermal control unit 618 is communicatively coupled to or includes one or more pumps 622 and one or more fans 624. Accordingly, embodiments are contemplated in which the thermal control unit 618 controls operation of the one or more pumps 622 and the one or more fans 624 based at least in part on a detected temperature from the at least one temperature sensor 620. For example, a flow rate of the one or more pumps 622 may be increased or the one or more pumps 622 may be activated based on detecting a temperature above a minimum threshold temperature level.

In some embodiments, either or both of the one or more pumps 622 and the one or more fans 624 may be incorporated into a chiller system or other form of heat exchanger system configured to cool at least a portion of the laser system 100. Accordingly, the pumps 622 and the fans 624 may be controlled based on the detected temperature, for example, to optimize a cooling rate of the laser system while minimizing energy consumption. Alternatively, or additionally, operation of the thermal control unit 618 may be controlled based at least in part on other parameters such as an operating state of the laser system 100. For example, the one or more pumps 622 may be activated based on determining that the laser system 100 is currently being operated or is set to a fire mode.

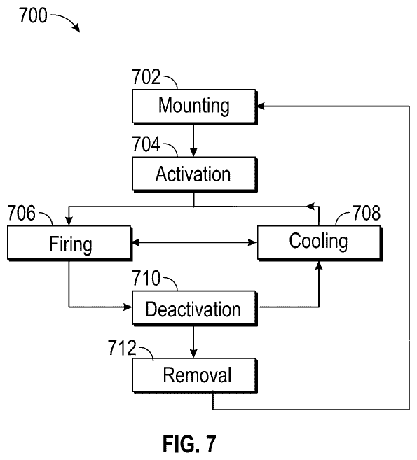

FIG. 7 illustrates an exemplary method 700 of operation for a laser system relating to some embodiments of the present disclosure. In some embodiments, at least a portion of the method 700 may be performed by at least one processor, such as at least one processor included in the laser system 100. Further, in some embodiments, portions of the method 700 may be separated between two or more separate processors. For example, a first processor may perform a first portion of steps and a second processor may perform a second portion of steps. Additionally, or alternatively, portions of the method 700 may be performed by other systems.

At step 702, at least a portion of the laser system 100 is mounted to a mountable device, such as a vehicle or another suitable mobile or stationary device. For example, the laser system 100 may be mounted to a firearm, turret, artillery device, drone, or other device such as any of the mountable devices described herein or other suitable devices that are not explicitly described. In some embodiments, the laser system 100 may be mounted to a mounting portion of said device. For example, the mounting structure 118 of the laser projector 116 may be mounted onto a structure of the device. Additionally, or alternatively, the housing structure 104 of the laser source 102 may be mounted to the device. In some embodiments, the housing structure 104 may be mounted in a similar location as the mounting structure 118. Alternatively, in some embodiments, the housing structure 104 may be mounted to the device in a different location or even completely separate and remote from the device.

At step 704, the laser system 100 is activated. In some embodiments, activation of the laser system 100 includes initiating the laser generator 110 and/or other portions of the laser system 100. In some embodiments, activation of the laser system 100 may be initiated responsive to an activation request, which may include either of manual or automated activation. For example, in some embodiments, a manual activation request is received from an operator. For example, a manual activation request may be received from an operator pressing a button, flipping a switch, or providing another suitable physical input. Additionally, the activation request may be transmitted as a signal from a remote device. For example, an operator may provide an input requesting activation to a user device disposed at a remote location from the laser system 100. Further still, embodiments are contemplated in which activation of the laser system 100 is at least partially automated. For example, the activation request may be received from either or both of a remote control system or an onboard control system coupled to the laser system 100.

At step 706, the laser system 100 is fired. In some embodiments, the laser system 100 may be fired responsive to a firing input, which may be received remotely or locally. For example, embodiments are contemplated in which the laser system 100 is configured to be fired responsive to a physical trigger mechanism disposed on the laser system 100. Additionally, in some embodiments, the laser system 100 may be fired responsive to an automated signal, which may be received locally from a processing system coupled to or included on the laser system 100. Alternatively, the laser system 100 may be fired based on a remote signal received from a remote control system or user device.

At step 708, the laser system 100 is cooled. In some embodiments, the laser system 100 is cooled by the thermal regulation unit 112. In some such embodiments, thermal regulation unit 112 is activated based at least in part on an activation or firing state of the laser system 100. Additionally, or alternatively, the thermal regulation unit 112 may be activated based at least in part on one or more detected temperatures of the laser system 100. For example, the thermal regulation unit 112 may be activated based on detecting that a portion of the laser system 100 is above a predetermined temperature threshold. Further, the thermal regulation unit 112 may be activated based on a percentage of phase change of a phase change material included in a heat mitigation system of the laser system 100. It should be understood that, in some embodiments, cooling of the laser system 100 may be carried out simultaneously while the laser system 100 is being fired. Additionally, in some embodiments, the laser system 100 is cooled after firing and even after the laser system 100 is deactivated.

At step 710, the laser system 100 is deactivated. In some embodiments, deactivation of the laser system 100 includes deactivating the laser generator 110 and/or other portions of the laser system 100. In some embodiments, deactivation of the laser system 100 may be executed responsive to a deactivation request, which may include either of manual or automated deactivation. For example, in some embodiments, a manual deactivation request is received from an operator. For example, a manual deactivation request may be received from an operator pressing a button, flipping a switch, or providing another suitable physical input. Additionally, the deactivation request may be transmitted as a signal from a remote device. For example, an operator may provide an input requesting deactivation to a user device disposed at a remote location from the laser system 100. Further still, embodiments are contemplated in which deactivation of the laser system 100 is at least partially automated. For example, the deactivation request may be received from either or both of a remote control system or an onboard control system coupled to the laser system 100.

At step 712, the laser system 100 is optionally removed from the mountable device. It should be understood that, in some embodiments, the laser system 100 may be selectively remounted to the mountable device or mounted to another device. Further still, embodiments are contemplated in which the laser system 100 may be used as a standalone system and may be used without mounting to another device.

In some embodiments, the thermal regulation unit of the laser systems described herein may comprise a multi-fluid heat exchanger, such as, for example, the multi-fluid heat exchanger system described in earlier filed U.S. patent application Ser. No. 18/175,209 filed Feb. 27, 2023, and entitled “MULTI-FLUID HEAT EXCHANGER FOR A LASER SYSTEM”, which has been incorporated by reference in its entirety. For example, a multi-fluid heat exchanger system incorporating two or more distinct fluids with distinct fluid loops. The multi-fluid heat exchanger technology may provide unique benefits in directed energy systems. In some embodiments, the multi-fluid heat exchanger may be operable to use a fluid from the operational environment as a working fluid.

For land-based platforms, such as the vehicle-mounted laser system 202, the multi-fluid heat exchanger may act as a bridge between a cooling system of the vehicle and the cooling system of the laser system. Such that a working fluid of the vehicle may be circulated through the multi-fluid heat exchanger to cool the working fluid of the laser system.

For water-based platforms, such as the submarine-mounted laser system described above, the multi-fluid heat exchanger may provide an intermediary between the laser system and the underwater environment. For example, the multi-fluid heat exchanger may provide a separate fluid loop for sea water to prevent corrosive sea water from being pumped through sensitive and/or high power equipment of the laser system. Accordingly, embodiments are contemplated in which the multi-fluid heat exchanger uses water from the operational environment as a secondary working fluid in addition to a primary working fluid, which is actually pumped through the laser system.

For air-based platforms, such as the drone-mounted laser system 302 described above, may operate similarly to the water-based platforms by using one or more fluids from the operational environment. For example, in some embodiments, forced convection of surrounding air flow as the system moves. Embodiments are contemplated in which forced convection associated with surrounding air flow is used to cool the laser system 100, for example by regenerating a phase change material of the thermal regulation unit 112. Embodiments are contemplated in which one or more cooling fins are included, for example, on an external surface of the aerial drone 304 to cool the laser generation system.

In some embodiments, the multi-fluid heat exchanger comprises any number of working fluids and corresponding fluid paths. For example, three working fluids may be used such as primary working fluid pumped through a portion of the laser system, a secondary working fluid that cools the primary working fluid, and a tertiary working fluid that cools the secondary working fluid. As an example, in some embodiments, the primary working fluid includes a first coolant fluid such as a water or oil-based fluid, circulated in a first fluid loop, the secondary working fluid includes a second coolant fluid, such as a water or oil-based fluid, circulated in a second fluid loop, and the tertiary working fluid includes a fluid from the operational environment, circulated through a third fluid loop, which may be open to the environment. Further, embodiments are contemplated in which two, four, five, or six different working fluids are used.

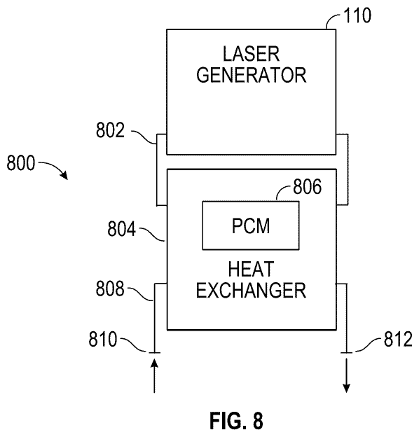

FIG. 8 illustrates an exemplary cooling system 800 for cooling the laser generator 110 of the laser system 100 relating to some embodiments of the present disclosure. In some embodiments, the thermal regulation unit 112 described above includes the cooling system 800. In some embodiments, a primary fluid loop 802 is included that circulates a primary fluid through at least a portion of the laser generator 110 or adjacent to the laser generator 110 to draw heat away from the laser generator 110. In some embodiments, the primary fluid is routed through a heat exchanger 804, as shown.

The heat exchanger 804 may include a phase change material (PCM) 806 disposed therein. For example, PCM 806 may be disposed within a PCM compartment or a plurality of PCM channels within the heat exchanger 804, such that heat may be removed from the primary fluid through melting of the PCM 806. At least a portion of the primary fluid loop 802 may circulate fluid adjacent to the PCM 806 such as through or in proximity to the PCM 806. Embodiments are contemplated in which the PCM 806 is disposed within a removable pack such that the PCM 806 may be removed and replaced with a fully regenerated solid PCM 806.

The primary fluid loop 802 may be operable to receive a primary working fluid, such as any of a water-based or an oil-based coolant, as well as other suitable heat transfer fluids not explicitly described herein. In some embodiments, the heat exchanger 804 is a multi-fluid heat exchanger operable to receive two or more working fluids or heat transfer fluids therein. For example, in some embodiments, a secondary fluid loop 808 is included that circulates a secondary working fluid through the heat exchanger 804. In some embodiments, the secondary fluid is circulated within the heat exchanger 804 near the PCM 806. Accordingly, the secondary fluid loop 808 may draw heat away from the PCM 806 to cool and regenerate the PCM 806 (i.e., solidify the PCM).

The secondary fluid loop 808 may be structurally separate from the primary fluid loop 802 such that the working fluids are not mixed. In some embodiments, the primary fluid loop 802 and the secondary fluid loop 808 are circulated through the heat exchanger 804 adjacent to one another. Accordingly, the secondary working fluid may draw heat away from the primary working fluid within the heat exchanger 804 to thereby cool the primary working fluid.

In some embodiments, the heat exchanger 804 comprises a crossflow arrangement such that the flow direction of the secondary fluid loop 808 is opposite the flow direction of the primary fluid loop 802. Alternatively, or additionally, embodiments are contemplated in which other flow arrangement are used. For example, in some embodiments, the heat exchanger 804 comprises a parallel flow arrangement in which working fluids flow in a similar direction. Further, in some embodiments, more than two working fluids are contemplated. For example, in some embodiments, a tertiary fluid may be circulated through the heat exchanger 804. Further still, in some embodiments, a second heat exchanger may be included in addition to the heat exchanger 804. Here, for example, the primary and second fluids may be circulated through a first heat exchanger while the second fluid and tertiary fluids are circulated through a second heat exchanger.

In some embodiments, the secondary fluid path 808 is open to an operational environment of the laser system 100 such that an operational fluid is circulated through the secondary fluid loop 808. For example, an inlet 810 of the secondary fluid loop 808 may be configured to receive a fluid therein from the operational environment and an outlet 812 may be configured to expel the fluid back into the operational environment. Alternatively, in some embodiments, the secondary fluid loop 808 may be a closed system but may be incorporated into an external system. For example, in some embodiments, the secondary fluid loop 808 is coupled to a cooling system of the vehicle or other device that the laser system 100 is mounted on.

The cooling system 800 may be incorporated into any of the laser systems described above including any of land-based, water-based, and air-based platforms. For example, the heat exchanger 804 may be coupled to a cooling system of the vehicle 204 such that a working fluid of the vehicle cooling system is circulated through the heat exchanger 804.

In some embodiments, any number of additional components not explicitly described herein may be incorporated into the cooling system 800. For example, the cooling system 800 may include additional cooling devices such as one or more fans and one or more chiller devices. However, it should be understood that chiller devices typically operate within a 30 degree range of orientation and may become damaged if the system is tilted out of a horizontal orientation. Accordingly, embodiments are contemplated in which a chiller is not included. Here, the cooling system 800 may be able to operate independent of system orientation. Further, in some embodiments, one or more pumps may be included to actively circulate fluid through the fluid loops. However, embodiments are contemplated in which working fluids are passively circulated, for example, responsive to movement of the system. For example, in some embodiments, air flow associated with the aerial drone 304 during travel may be used to cool the laser generation device.

In some embodiments, the cooling system 800 is operable to provide continuous high duty cycle operation to the laser system 100. For example, the multi-fluid heat exchanger may allow continuous regeneration of the PCM 806 while the heat load associated with laser generation is active thereby increasing a run time of the laser system.

Embodiments above describe laser-based systems such as laser weapon systems and associated cooling and thermal regulation systems; however, it should be understood that other directed energy systems are also contemplated. For example, in some embodiments, another form of directed energy system may be included such as any of a laser system, microwave system, millimeter wave system, particle beam system, or sound beam system, as well as combinations thereof. Any form of the directed-energy systems described above, as well as others not explicitly described herein, may be integrated into the vehicle and drone mounted systems described above.

In some embodiments, the cooling system described herein is implemented into a non-lethal counter-personnel repel system, such as a millimeter wave system. For example, the cooling system may be operable to cool a wave source of the millimeter wave system during and after operation. In some embodiments, process fluid such as high-purity water or a glycol-water mixture is run through the wave generating portion of the millimeter wave system to cool the wave generating portion. The process fluid may then be routed to the multi-fluid heat exchanger described herein to cool the process fluid. However, it should be understood that other cooling system flow arrangements not explicitly described herein are also contemplated.

In some embodiments, the cooling system described herein may be integrated into other types of systems to remove heat. For example, the cooling system may generally remove heat associated with operation of any of vehicles, drones, robotic equipment, and other devices. For example, in some embodiments, the cooling system may be used to cool electronic devices that produce heat during operation. Further, embodiments are contemplated in which the cooling system may be operable to cool multiple separate devices simultaneously. For example, a respective flow path through the multifluid heat exchanger may be included for each device.

Clause 1. A laser weapon system configured to be coupled to at least one vehicle, the laser weapon system comprising: a laser source portion comprising: a power source; a laser generator; a thermal regulation unit; and a control unit; at least one fiber optic cable attached to the laser generator; and a laser projector portion coupled to the laser source portion via the at least one fiber optic cable such that a laser produced by the laser generator is provided to the laser projector portion, the laser projector portion comprising laser transmitter optics configured to focus a laser at a target, wherein the laser projector portion is configured to be mounted on the at least one vehicle.

Clause 2. The laser weapon system of clause 1, wherein the laser weapon system is integrated into an at least semi-autonomous drone, and wherein the laser projector portion is mounted onto a portion of the at least semi-autonomous drone.

Clause 3. The laser weapon system of any of clauses 1-2, wherein the laser weapon system configured to be disposed on an automobile, and wherein the laser projector portion is mounted onto a selectively removable turret weapon system removably mounted to the automobile.

Clause 4. The laser weapon system of any of clauses 1-3, wherein the at least one vehicle is a subterranean drone, and wherein the laser projector portion is mounted onto a front portion of the subterranean drone.

Clause 5. The laser weapon system of any of clauses 1-4, wherein the laser source portion is disposed at a surface portion located at a distinct location from the subterranean drone.

Clause 6. The laser weapon system of any of clauses 1-5, wherein the subterranean drone is tethered to the at least one fiber optic cable.

Clause 7. A drone-mounted directed-energy system configured to be coupled to a drone, the drone-mounted directed-energy system comprising: a directed-energy source portion comprising: a directed-energy generator; a thermal regulation unit; and a control unit; at least one fiber optic cable attached to the directed-energy generator; and a directed-energy projector portion coupled to the directed-energy source portion via the at least one fiber optic cable such that directed-energy produced by the directed-energy generator is provided to the directed-energy projector portion, wherein the directed-energy projector portion is configured to be mounted on the drone.

Clause 8. The drone-mounted directed-energy system of clause 7, wherein the thermal regulation unit is not orientation sensitive.

Clause 9. The drone-mounted directed-energy system of any of clauses 7-8, wherein the drone is an aerial drone and the drone-mounted directed-energy system is configured for aerial use.

Clause 10. The drone-mounted directed-energy system of any of clauses 7-9, wherein the thermal regulation unit includes uses forced air convection associated with travel of the aerial drone to cool a phase change material disposed in the thermal regulation unit.

Clause 11. The drone-mounted directed-energy system of any of clauses 7-10, wherein the drone is a submarine drone and the drone-mounted directed-energy system is configured for submarine use in a submarine environment.

Clause 12. The drone-mounted directed-energy system of any of clauses 7-11, wherein the thermal regulation unit comprises a multi-fluid heat exchanger that circulates water from the submarine environment to cool a phase change material disposed in the thermal regulation unit.

Clause 13. The drone-mounted directed-energy system of any of clauses 7-12, wherein the thermal regulation unit comprises a multi-fluid heat exchanger, the multi-fluid heat exchanger including: a primary fluid circulated therein, the primary fluid configured to cool the directed-energy generator; a phase change material disposed within at least one compartment of the multi-fluid heat exchanger, the phase change material operable to absorb heat from the directed-energy generator; and a secondary fluid circulated therein, the secondary fluid configured to regenerate the phase change material.

Clause 14. The drone-mounted directed-energy system of any of clauses 7-13, further comprising: one or more pumps operable to circulate the primary fluid and the secondary fluid through respective fluid loops.

Clause 15. A vehicle-mounted directed-energy system configured to be coupled to a vehicle, the vehicle-mounted directed-energy system comprising: a directed-energy source portion comprising: a directed-energy generator; a thermal regulation unit; and a control unit; at least one fiber optic cable attached to the directed-energy generator; and a directed-energy projector portion coupled to the directed-energy source portion via the at least one fiber optic cable such that a directed-energy produced by the directed-energy generator is provided to the directed-energy projector portion, wherein the directed-energy projector portion is configured to be mounted on a portion of the vehicle.

Clause 16. The vehicle-mounted directed-energy system of clause 15, wherein the directed-energy source portion is coupled to a vehicle battery of the vehicle.

Clause 17. The vehicle-mounted directed-energy system of any of clauses 15-16, wherein the thermal regulation unit comprises a multi-fluid heat exchanger.

Clause 18. The vehicle-mounted directed-energy system of any of clauses 15-17, wherein the multi-fluid heat exchanger is integrated with a vehicle cooling system of the vehicle such that a vehicle coolant from the vehicle cooling system is circulated through the multi-fluid heat exchanger.

Clause 19. The vehicle-mounted directed-energy system of any of clauses 15-18, further comprising: a directed-energy mounting structure operable to removably coupled the vehicle-mounted directed-energy system onto a portion of the vehicle.

Clause 20. The vehicle-mounted directed-energy system of any of clauses 15-19, wherein the directed-energy mounting structure includes one or more vibration damping structures operable to mitigate effects of vibration associated with motion of the vehicle.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A laser weapon system configured to be coupled to at least one vehicle, the laser weapon system comprising:
a laser source portion comprising:
a power source;
a laser generator;
a thermal regulation unit; and
a control unit;
at least one fiber optic cable attached to the laser generator; and
a laser projector portion coupled to the laser source portion via the at least one fiber optic cable such that a laser produced by the laser generator is provided to the laser projector portion, the laser projector portion comprising laser transmitter optics configured to focus a laser at a target,
wherein the laser projector portion is configured to be mounted on the at least one vehicle.

2. The laser weapon system of claim 1, wherein the laser weapon system is integrated into an at least semi-autonomous drone, and wherein the laser projector portion is mounted onto a portion of the at least semi-autonomous drone.

3. The laser weapon system of claim 1, wherein the laser weapon system configured to be disposed on an automobile, and wherein the laser projector portion is mounted onto a selectively removable turret weapon system removably mounted to the automobile.

4. The laser weapon system of claim 1, wherein the at least one vehicle is a subterranean drone, and wherein the laser projector portion is mounted onto a front portion of the subterranean drone.

5. The laser weapon system of claim 4, wherein the laser source portion is disposed at a surface portion located at a distinct location from the subterranean drone.

6. The laser weapon system of claim 5, wherein the subterranean drone is tethered to the at least one fiber optic cable.

7. A drone-mounted directed-energy system configured to be coupled to a drone, the drone-mounted directed-energy system comprising:
a directed-energy source portion comprising:
a directed-energy generator;
a thermal regulation unit; and
a control unit;
at least one fiber optic cable attached to the directed-energy generator; and
a directed-energy projector portion coupled to the directed-energy source portion via the at least one fiber optic cable such that directed-energy produced by the directed-energy generator is provided to the directed-energy projector portion,
wherein the directed-energy projector portion is configured to be mounted on the drone.

8. The drone-mounted directed-energy system of claim 7, wherein the thermal regulation unit is not orientation sensitive.

9. The drone-mounted directed-energy system of claim 8, wherein the drone is an aerial drone and the drone-mounted directed-energy system is configured for aerial use.

10. The drone-mounted directed-energy system of claim 9, wherein the thermal regulation unit includes uses forced air convection associated with travel of the aerial drone to cool a phase change material disposed in the thermal regulation unit.

11. The drone-mounted directed-energy system of claim 7, wherein the drone is a submarine drone and the drone-mounted directed-energy system is configured for submarine use in a submarine environment.

12. The drone-mounted directed-energy system of claim 11, wherein the thermal regulation unit comprises a multi-fluid heat exchanger that circulates water from the submarine environment to cool a phase change material disposed in the thermal regulation unit.

13. The drone-mounted directed-energy system of claim 7, wherein the thermal regulation unit comprises a multi-fluid heat exchanger, the multi-fluid heat exchanger including:
a primary fluid circulated therein, the primary fluid configured to cool the directed-energy generator;
a phase change material disposed within at least one compartment of the multi-fluid heat exchanger, the phase change material operable to absorb heat from the directed-energy generator; and
a secondary fluid circulated therein, the secondary fluid configured to regenerate the phase change material.

14. The drone-mounted directed-energy system of claim 13, further comprising:
one or more pumps operable to circulate the primary fluid and the secondary fluid through respective fluid loops.

15. A vehicle-mounted directed-energy system configured to be coupled to a vehicle, the vehicle-mounted directed-energy system comprising:
a directed-energy source portion comprising:
a directed-energy generator;
a thermal regulation unit; and
a control unit;
at least one fiber optic cable attached to the directed-energy generator; and
a directed-energy projector portion coupled to the directed-energy source portion via the at least one fiber optic cable such that a directed-energy produced by the directed-energy generator is provided to the directed-energy projector portion,
wherein the directed-energy projector portion is configured to be mounted on a portion of the vehicle.

16. The vehicle-mounted directed-energy system of claim 15, wherein the directed-energy source portion is coupled to a vehicle battery of the vehicle.

17. The vehicle-mounted directed-energy system of claim 15, wherein the thermal regulation unit comprises a multi-fluid heat exchanger.

18. The vehicle-mounted directed-energy system of claim 17, wherein the multi-fluid heat exchanger is integrated with a vehicle cooling system of the vehicle such that a vehicle coolant from the vehicle cooling system is circulated through the multi-fluid heat exchanger.

19. The vehicle-mounted directed-energy system of claim 15, further comprising:
a directed-energy mounting structure operable to removably coupled the vehicle-mounted directed-energy system onto a portion of the vehicle.

20. The vehicle-mounted directed-energy system of claim 19, wherein the directed-energy mounting structure includes one or more vibration damping structures operable to mitigate effects of vibration associated with motion of the vehicle.
